(19) United States
(12) Patent Application Publication
(10) Pub. No.: US 2025/0249536 A1
(43) Pub. Date: Aug. 7, 2025

(54) Laser Engraving System

(71) Applicant: SuperNova International Inc., Mason, MI (US)

(72) Inventors: Tong Li, Haslett, MI (US); Bentley Edmond John Camphorst, Haslett, MI (US)

(21) Appl. No.: 18/814,549

(22) Filed: Aug. 25, 2024

Related U.S. Application Data
(60) Provisional application No. 63/549,182, filed on Feb. 2, 2024.

(51) Int. Cl. B23K 26/362; B23K 26/70

(52) U.S. Cl. CPC B23K 26/362; B23K 26/706

(57) ABSTRACT

A laser engraving system in which a galvanometer controlled laser source is mounted within a protective casing with the focal point of the laser source within the bottom edge plane of the casing. The engraving process is performed while maintaining the casing bottom edge on or in substantial parallel proximity and close contact with the surface of the substrate to be engraved such that the escape of radiation to operator eye level is prevented while at all times maintaining the laser source in focus.

### CROSS-REFERENCE TO RELATED APPLICATION

This application claims priority to and the benefit of U.S. Provisional Application Ser. No. 63/549,182, filed Feb. 2, 2024, the entire disclosure of which is hereby incorporated by reference.

### SUMMARY OF THE DISCLOSURE

This document discloses a method and apparatus for operating a laser engraving or “marking” system in such a manner as to substantially reduce or eliminate the escape of radiation to eye level from a galvanometric laser source mounted within a protective casing.

In general, this objective is achieved by mounting a galvanometric laser source within a protective casing with an open bottom such that the laser beam is focused at and within the bottom edge plane of the casing and the casing is positioned such that the open bottom edge plane is in close or contacting parallel association with the target surface to be marked by engraving. By virtue of this arrangement there is little or no escape of radiation to operator eye level during a laser engraving process.

Further in general, the apparatus disclosed herein includes an open bottom protective casing for a galvanometric laser source or the like wherein the casing is mounted in a frame system having the capability of motor controlled left-right horizontal and vertical movement of the casing as well as manual adjustment of the angle of the bottom edge plane of the protective casing so that the edge plane can be brought into substantially close parallel association with the surface to be engraved whether that surface is horizontal or angled.

### BRIEF DESCRIPTION OF THE DRAWINGS

The disclosure is best understood from the following detailed description when read in conjunction with the accompanying drawings. It is emphasized that, according to common practice, the various features of the drawings may or may not be to-scale.

FIG. 1 shows in perspective view of a protective galvanometric laser casing mounted within a framing system having the aforementioned movement and adjustment capabilities;

FIG. 2 is a front view of the apparatus system of FIG. 1 with the casing in a raised position and a front door panel of the casing in a raised position;

FIG. 3 is a view of the system similar to FIG. 1 with the door of the protective casing in a closed position;

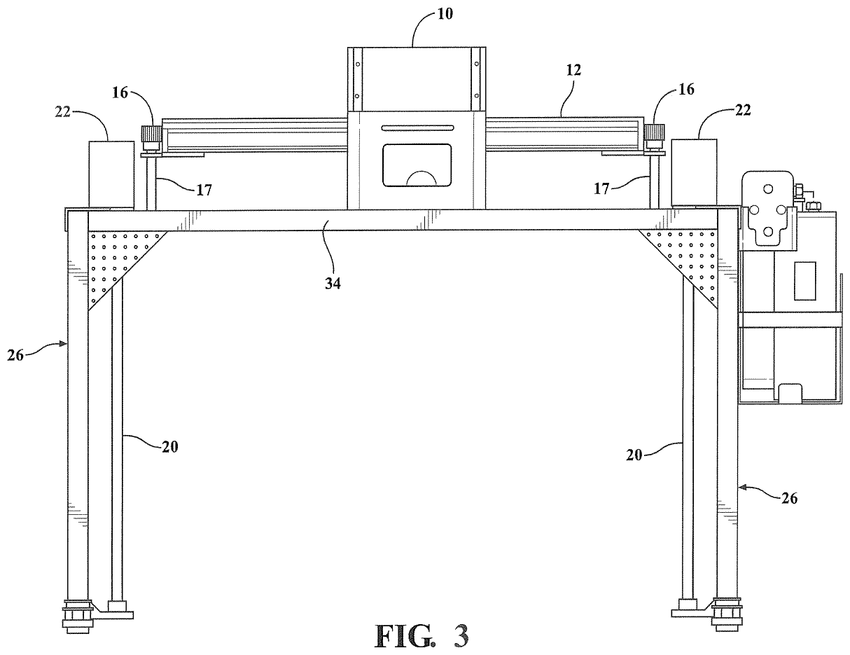

FIG. 4 is a bottom view of the apparatus of FIGS. 1, 2 and 3;

FIG. 5 is a side view of the apparatus of FIGS. 1-4;

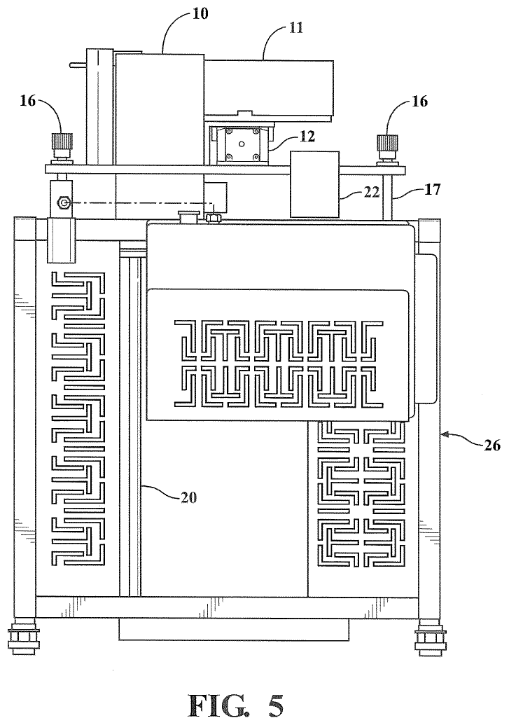

FIG. 6 is a perspective view of the protective casing looking into the open bottom with a sliding door in a raised position;

FIG. 7 is a front view of the apparatus of FIGS. 1-5 with the protective casing in the lowermost position;

FIG. 8 is a perspective view of the system of FIG. 1 in combination with a height adjustable table for carrying a substrate to be engraved; and

FIG. 9 is a top view of the apparatus of FIG. 8 showing the means for stabilizing and producing left-right movement of the protective casing which holds the galvanometric laser head.

### DETAILED DESCRIPTION OF AN ILLUSTRATIVE EMBODIMENT

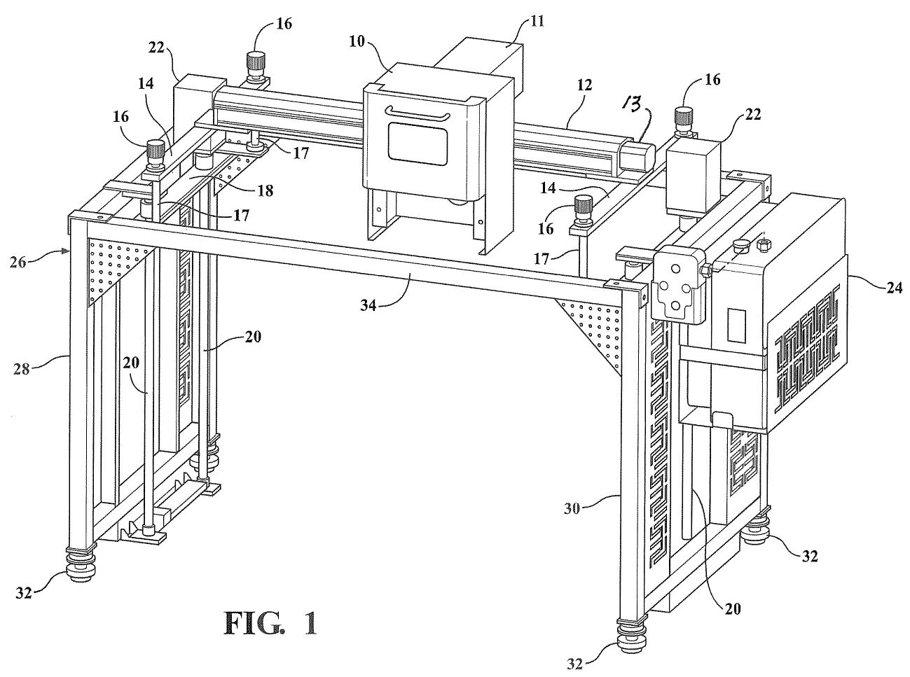

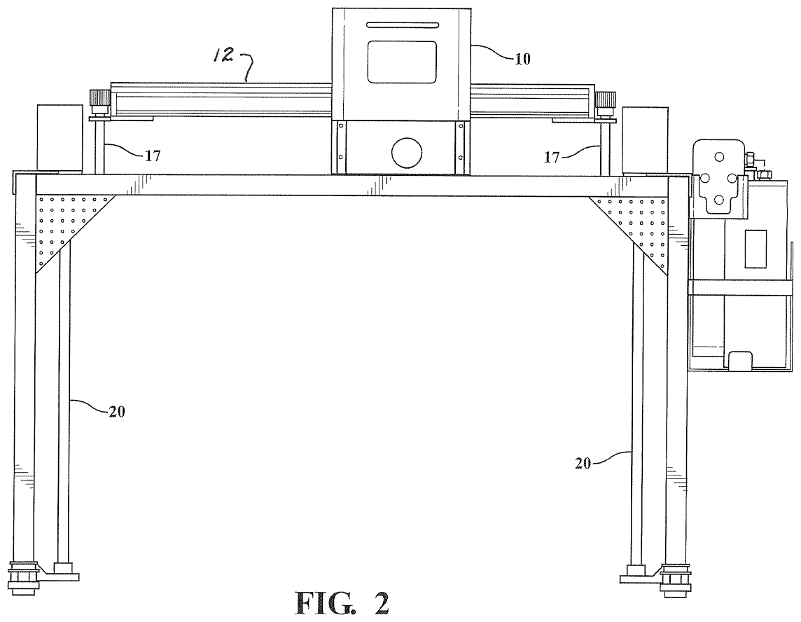

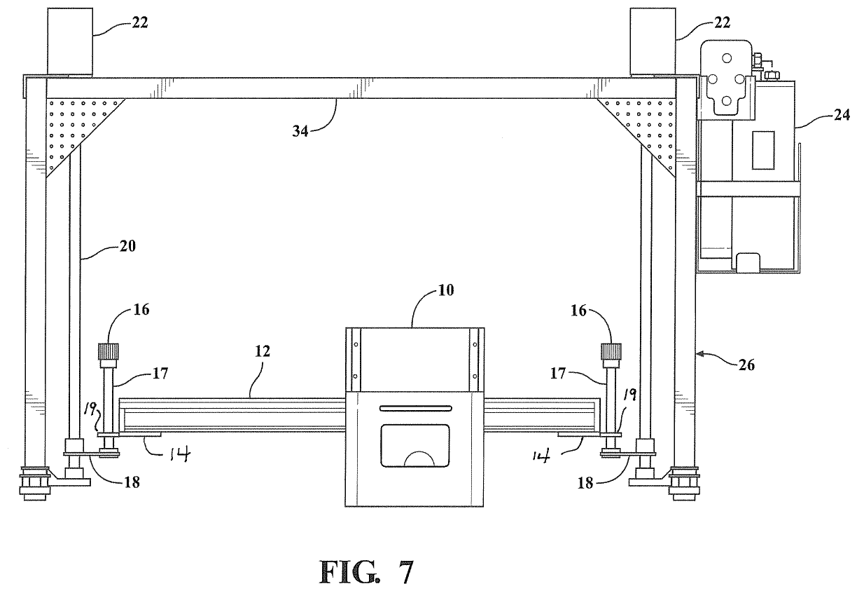

Referring to the figures, there is shown a protective casing 10 containing a galvanometric laser with a lens 37 mounted within an outer frame 26 configured to allow a workpiece or “substrate” to be placed within the frame and below the casing during an engraving process. The casing 10 has an open bottom with a planar edge and is mounted on a structure 12 providing horizontal travel powered by a motor 13. The beam structure 12 is connected to an appendage 11 associated with the main casing 10. In addition, means including parallel left and right beams 18 and four full length screw shafts 20 driven by motors 22 are provided to provide for vertical movement of the beam structure 12 and casing 10 relative to the outer frame 26 from and between the raised position shown in FIGS. 1 and 2 and a fully lowered position as shown in FIG. 7. The screw shafts 20 on each side are interconnected by belts (not shown) near the bottoms to synchronize each side's rotations. Further means including four short leveler screw shafts 17 rotatable by hand knobs 16 are provided between beams 14 and beams 18 to allow for angular adjustment of the bottom edge plane of the casing 10 to match any slope in the surface to be engraved. The bottoms of the shafts 17 can slide on the bottom beam brackets but ball joints can also be used if deemed necessary.

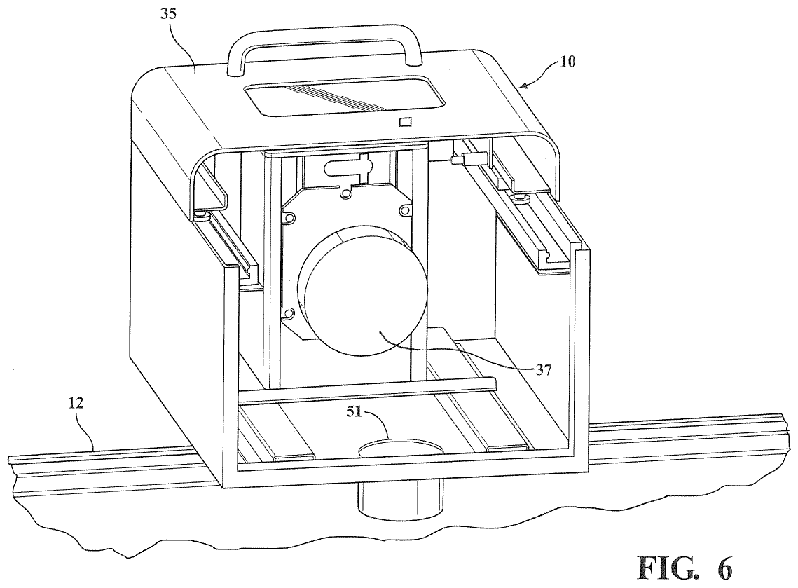

For clarity, the casing 10 must, to achieve the aforementioned objectives, be positioned vertically and angularly such that the bottom edge plane of the casing is essentially on or in such close proximity to the surface of the object to be engraved as to prevent the escape of radiation from the laser within the casing to the eye level of the operator. This is achieved by closing the front sliding door of the casing, using the four hand knobs 16 as necessary to adjust the angular orientation of the bottom edge plane of the casing to match the plane of the workpiece, and exciting the motors 22 as necessary by switches and/or buttons on the control box 24 to bring the casing 10 to the work surface. As shown in FIG. 6, an external vacuum system is preferably connected to the casing 10 by way of a fitting 51 on the back of the casing to collect fumes and prevent the escape thereof to the operator area. The control box 24 is wired to operate both motors 22 to drive the casing vertically into and out of contact with the surface of a workpiece/substrate and motor 13 to position the casing 10 horizontally.

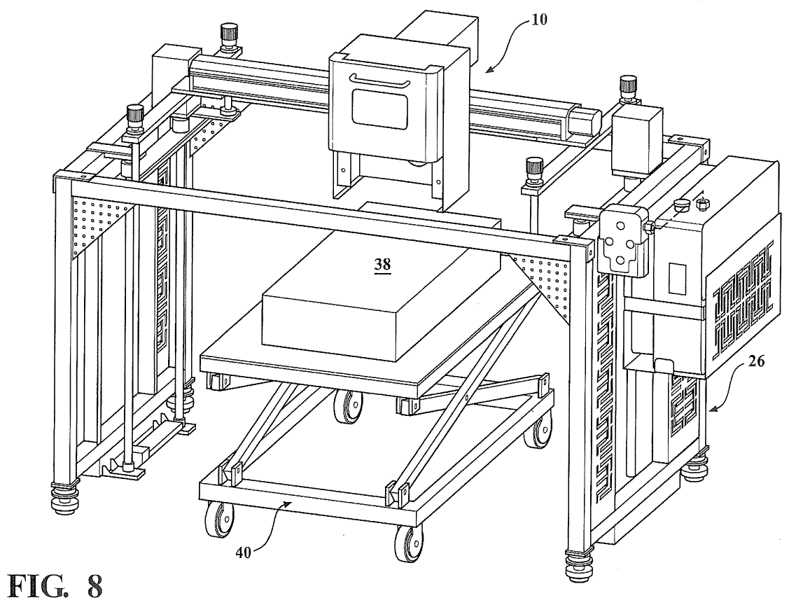

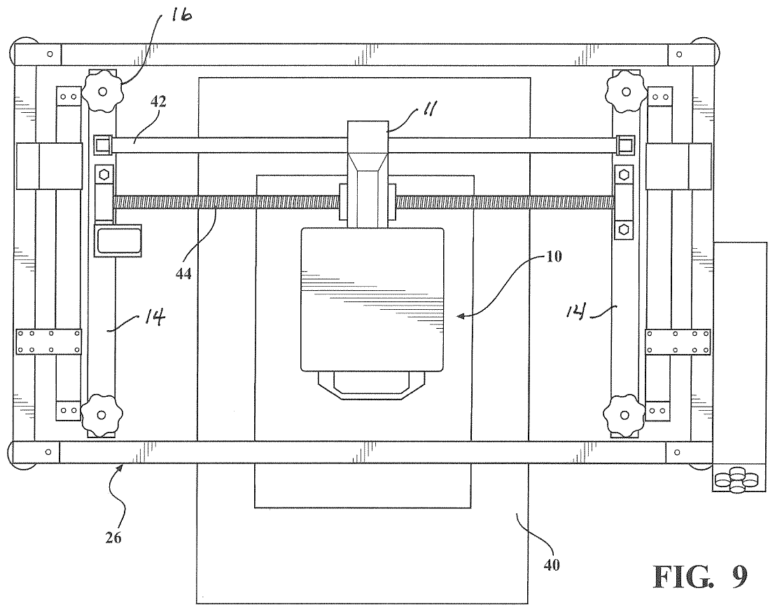

The fixed outer frame 26 is of rectangular design with side frames 28 mounted on wheels 32. The side frames 28 include vertical and horizontal interconnected box beams of metal construction and the side frames 28 and 30 are joined by upper front and rear horizontal beams 34 to provide a structure of suitable dimensions to accommodate the substrates to be engraved as, for example, illustrated in FIGS. 8 and 9 wherein the substrate 38 is mounted on a table 40 which is height adjustable.

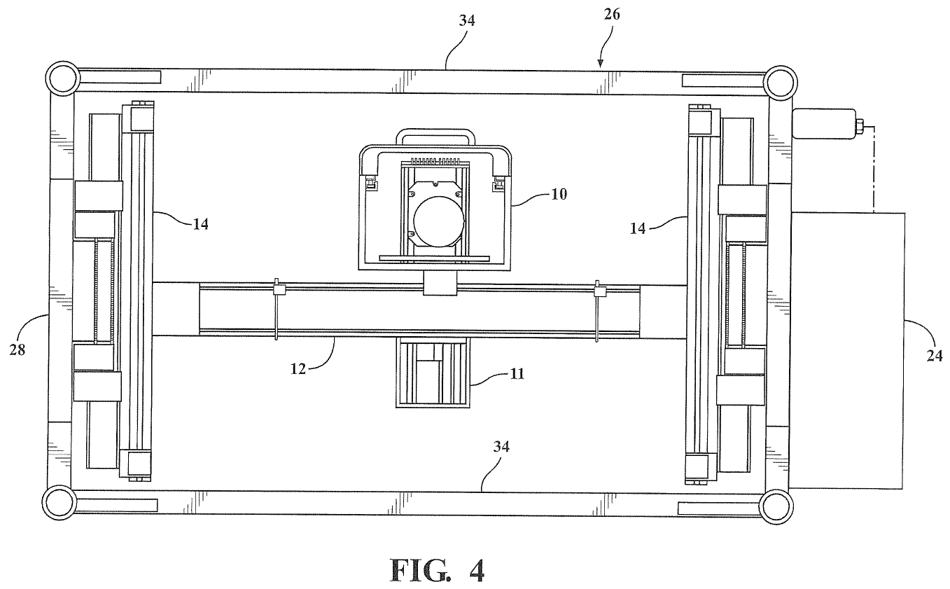

Looking to FIGS. 4, 6, 7, 8 and 9 the protective casing for a galvanometric laser source with lens 37 of conventional design is structured so as to define an open bottom of which the three sides define an edge plane that, before angular adjustment of the beams 14 and 18 is made, is horizontal within the frame structure 26. The casing 10 has a vertically slidable front door 35 which can be raised or lowered to provide access to a laser source with lens 37 of conventional galvanometric design. The lens 37 is positioned within the casing 10 such that the focal point of the laser beam is precisely located within the bottom edge plane of the casing.

As illustrated in FIG. 7 the casing 10 and the beam 12 can be raised and lowered by the motors 22 using circuitry and operator buttons in the control box 24 to such an extent that the casing can be dropped down to any selected lower level. As further shown in FIG. 7, the leveler screw shafts 17 extend through threaded brackets 19 attached to the structure 12 and rest on brackets attached to the beams 18 that are raised and lowered by motors 18. Turning any or all of shafts 17 can change the level/angle of the beams 14 that directly carry the structure 12 so as to make the bottom plane of casing 10 match the plane of the substrate to be engraved. The bottoms of the screw shafts rest slidingly on the attachment brackets to allow for the change in the level of structure 12. As stated above, roll bearings may be used in place of a sliding contact if necessary to achieve greater degrees of angular adjustment. The brackets 19, on the other hand, act as nuts and move up or down according to the direction in which the leveler shafts 17 are turned.

As shown in FIGS. 8 and 9 horizontal positioning of the casing 10 relative to a substrate 38 to be engraved placed on the height adjustable table 40 is provided by a motor driven screw shaft 44 connected between the parallel left and right beams 18 and extending through the rear appendage 11 of the casing 10. In addition, a guide shaft 42 which extends through the protective casing 10 as best shown in FIG. 9 is provided to stabilize the casing during horizontal movement. Again, the left to right movement is produced by means of motors connected to the screw shaft 44.

In operation, a substrate 38 maybe placed within the frame system 26 either with or without a height adjustable table according to the size and type of substrate to be engraved. If the surface to be engraved is flat and horizontal the casing 10 is maintained with a bottom plane in a horizontal position and is lowered down to the point where the bottom edge plane of the casing is on or substantially on the substrate surface. During movement of the casing as described above, the bottom edge of casing is preferably out of contact with the substrate to prevent marring.

If the surface being engraved is non-horizontal, the angular attitude of the casing 10 is adjusted by means of the thumb wheels adjusters 16 and the leveler shafts 17 passing through internally threaded nuts 19 connected to beams 14 that carry the main beam structure 12. The leveler shafts 17 rest on brackets connected to beams 18 to bring the bottom edge plane of the casing 10 into parallel relationship with the plane of the surface to be engraved. Thereafter the casing in lowered so that the bottom edge plane is brought into contact or substantial proximity to the surface to be engraved and the marking sequence is carried out by control of the galvanometric laser which, according to conventional design, includes a system of mirrors for moving the focal point of the laser in a two-dimensional fashion to produce the desired character and shape of the marks being created.

When the marking process is completed, the motor system is again activated to raise the casing 10 relative to the substrate and the substrate is removed from its position within the framing system 26.

By way of review, the support system for the casing 10 within the outer frame 26 includes the beam 12 and the full-length screw shafts 20 driven by synchronized motors 22 to move the first inner frame created by beams 18 vertically toward the substrate to be engraved. If the surface of the substrate is non-horizontal, the angular attitude of the casing is adjusted to make the bottom edge plane of the casing parallel to the substrate surface by turning the hand knobs of the individual leveler shafts 17 to adjust the attitudes of the second inner frame beams 14 until the bottom plane of the casing matches the slope of the substrate surface. Moving the casing downward by motors 22 does not change the angular attitude of the casing as the attitude control system is effectively independent of the vertical control system. The laser source remains in focus in the bottom edge plane of the casing for the most effective removal of substrate material.

What is claimed is:

1. A method of engraving a substrate surface comprising the steps of:
placing a laser radiation source in a protective casing with an open bottom defining an edge plane;
arranging the laser radiation source within the casing such that the focal point of the laser beam produced by the source is within the edge plane;
placing the casing with the edge substantially on and parallel to the substrate surface; and
operating the laser source to engrave the substrate surface while maintaining the casing edge plane substantially on and parallel to the substrate surface to substantially prevent the escape of radiation from the substrate surface being engraved to operator eye level.

2. A laser engraving system comprising:
a laser radiation source;
a protective casing having an open bottom defining an edge plane;
said laser source being positioned within said casing such that the focal point of the laser source is within the edge plane;
means for placing said casing over a substrate surface to be engraved and maintaining said casing edge plane on or sufficiently close to said surface to substantially prevent the escape of radiation to operator eye level from the substrate during operation of said laser source.

3. A laser engraving system as defined in claim 2 wherein said casing is mounted to a support frame having means for varying the angular orientation of said casing. to match the angular orientation of the substrate surface.

4. A laser engraving system as defined in claim 2 further including a substrate support table locatable within in beneath said support frame.

5. A laser engraving system as defined in claim 3 wherein the support table is height adjustable.

6. A laser engraving system as defined in claim 3 further including means for producing left to right horizontal movement capabilities of the protective casing relative to the support frame.

7. A laser engraving system comprising:
a laser source;
a protective casing containing said laser source and having an open bottom with a planar edge;
a frame structure;
a first positioning structure within said frame structure and providing vertical positioning of said casing relative to said frame structure; and
a second positioning structure between said casing and said first positioning system for varying the angular orientation of said casing relative to said first positioning structure
whereby said casing may be positioned with said planar edge in sufficiently close proximity to a target surface to eliminate the escape of radiation from said casing at operator eye level.
